(19) United States
(12) Patent Application Publication
(10) Pub. No.: US 2009/0006623 A1
(43) Pub. Date: Jan. 1, 2009

(54) Secure Sharing of Resources Over a Network

(76) Inventors: Asher Chen, Haifa (IL); Tomer Cohen, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/768,198

(22) Filed: Jun. 26, 2007

(51) Int. Cl. G06F 15/173

(52) U.S. Cl. 709/226

(57) ABSTRACT

A resource sharing system including a resource manager maintaining a list of resources that are accessible to a first computer, and a rights manager maintaining a list of users that may access any of the resources of the first computer, the resource manager and rights manager processing a request to use any of the resources, the request being sent from a second data communications client at a second computer and received at a first data communications client at the first computer, the first data communications client recognizing communications from the second data communications client as associated with a user identity that is known to the client, and the rights manager allowing the transfer of data between the resource and the second data communications client via the first data communications client upon determining that the user is authorized to use the requested resource.

### FIELD OF THE INVENTION

The present invention relates to sharing of resources in general and more particularly to facilitating the secure sharing of resources over a network.

### BACKGROUND OF THE INVENTION

Instant messaging (IM) is becoming an increasingly popular way for people to communicate with each other. Given that IM programs typically have a built-in authentication process, it is possible to share content such as files, pictures, and music without worrying that an unauthorized user is trying to access that content.

Hardware resources such as printers are easily shared in a local area network (LAN), but sharing such resources outside of a LAN is more complex. Although there are currently a variety of ways to share hardware devices remotely, these typically require an advanced level of technical knowledge to configure the necessary hardware and software and to overcome firewalls and other security mechanisms that prevent users outside of a LAN from accessing resources within the LAN.

### SUMMARY OF THE INVENTION

In one aspect of the present invention a resource sharing system is provided including a resource manager configured to maintain a list of resources that are accessible to a first computer, and a rights manager configured to maintain a list of users that may access any of the resources of the first computer, where the resource manager and rights manager are configured to process a request to use any of the resources, where the request is sent from a second data communications client at a second computer and received at a first data communications client at the first computer, where the first data communications client is configured to recognize communications from the second data communications client as associated with a user identity that is known to the client, and where the rights manager is configured to allow the transfer of data between the resource and the second data communications client via the first data communications client upon determining that the user is authorized to use the requested resource.

In another aspect of the present invention the rights manager is configured to maintain a list of any restrictions applicable to any of the users regarding any of the resources.

In another aspect of the present invention the data communications clients are configured to communicate with each other unhindered by firewalls or other security measures implemented to protect any of the computers.

In another aspect of the present invention the data communications clients are instant messaging (IM) programs.

In another aspect of the present invention the computers are each on a different network.

In another aspect of the present invention a resource sharing method is provided including maintaining a list of resources that are accessible to a first computer, maintaining a list of users that may access any of the resources of the first computer, receiving a request to use any of the resources, where the request is sent from a second data communications client at a second computer and received at a first data communications client at the first computer, determining whether the request is associated with a user identity that is known to the client and whether the user is authorized to use the requested resource, and allowing the transfer of data between the resource and the second data communications client via the first data communications client upon determining that the user is authorized to use the requested resource.

In another aspect of the present invention the maintaining a list of users includes maintaining a list of any restrictions applicable to any of the users regarding any of the resources.

In another aspect of the present invention the method further includes performing any of the steps where the data communications clients are configured to communicate with each other unhindered by firewalls or other security measures implemented to protect any of the computers.

In another aspect of the present invention the method further includes performing any of the steps where the data communications clients are instant messaging (IM) programs.

In another aspect of the present invention the method further includes performing any of the steps where the computers are each on a different network.

In another aspect of the present invention a computer program is provided embodied on a computer-readable medium, the computer program including a first code segment operative to maintain a list of resources that are accessible to a first computer, a second code segment operative to maintain a list of users that may access any of the resources of the first computer, a third code segment operative to receive a request to use any of the resources, where the request is sent from a second data communications client at a second computer and received at a first data communications client at the first computer, a fourth code segment operative to determine whether the request is associated with a user identity that is known to the client and whether the user is authorized to use the requested resource, and a fifth code segment operative to allow the transfer of data between the resource and the second data communications client via the first data communications client upon the fourth code segment determining that the user is authorized to use the requested resource.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a resource sharing system over a network, constructed and operative in accordance with an embodiment of the present invention;

FIG. 2 is a simplified flowchart illustration of an exemplary method of operation of the system of FIG. 1, operative in accordance with an embodiment of the present invention; and

FIGS. 3A-3C are simplified illustrations of exemplary interface elements of the system of FIG. 1, operative in accordance with an embodiment of the present invention.

### DETAILED DESCRIPTION OF THE INVENTION

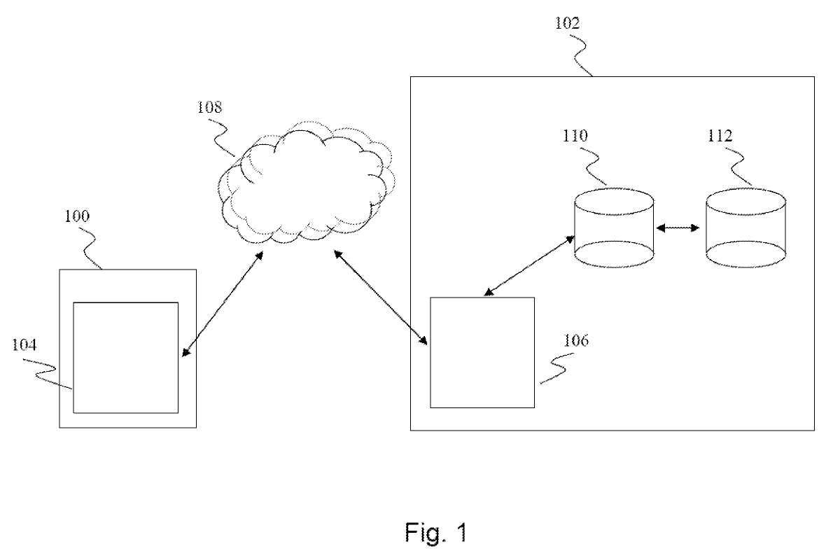

Reference is now made to FIG. 1, which is simplified conceptual illustration of a resource sharing system over a network constructed and operative in accordance with an embodiment of the present invention. In the system of FIG. 1 two computers 100 and 102, each typically being on a different network, are configured with data communications client programs 104 and 106 respectively, where preferably clients 104 and 106 are each an instant messaging (IM) program such as MSN Messenger™, commercially-available from Microsoft Corporation. Data communications clients 104 and 106 are preferably configured to communicate with each other via a network 108, such as the Internet, and to recognize communications to and from each other as being in the context of identities, such as user names, that are known to clients 104 and 106. Clients 104 and 106 are also preferably configured communicate with each other unhindered by firewalls or other security measures that may be implemented to protect computers 102 and 100. Computer 102 includes a resource manager 110 which maintains a list of resources of computer 102, such as storage devices, printers, or other hardware or software that are accessible to computer 102. Computer 102 also includes a rights manager 112 which maintains a list of users that may access the resources of computer 102, authorizations indicating which of the resources of computer 102 each user may use, and any restrictions on a user's use of a resource.

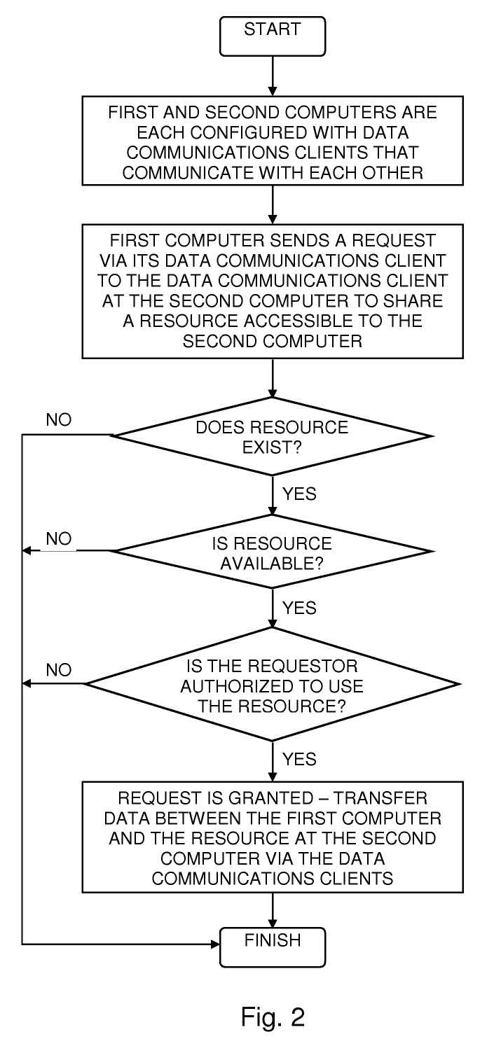

Reference is now made to FIG. 2, which is a simplified flowchart illustration of an exemplary method of operation of the system of FIG. 1, operative in accordance with an embodiment of the present invention. In the method of FIG. 2 computer 100 makes a request to share a specific resource accessible to computer 102, such as to send a print job to a printer that is accessible to computer 102 or to stream a music file from a CD on a CD player accessible to computer 102, where the music file is to be played by computer 100. Computer 100 instructs data communications client 104 to send the request to data communications client 106. The request includes the identity of the sender that is known to data communications client 104, and a specific request to use a resource that is accessible to computer 102. Data communications client 106 recognizes the request as a resource sharing request and notifies the rights manager 112 of the request. Alternatively, rights manager 112 monitors client 106 for receipt of the request, and thus client 106 need not notify manager 112 of its arrival. Rights manager 112 queries resource manager 110 to check if the requested resource exists and/or is available, and, if so, determines whether the sender of the request is authorized to use the resource. If the sender of the request is authorized to use the identified resource then rights manager 112 notifies data communications client 106 that the request made by data communications client 104 to share the identified resource may be granted. Data communications client 106 then facilitates the transfer of data between data communications client 104 and the resource in connection with the request. However, if is the sender is not authorized to use the specified resource then rights manager 112 notifies data communications client 106 that the request by data communications client 104 to share the identified resource is denied.

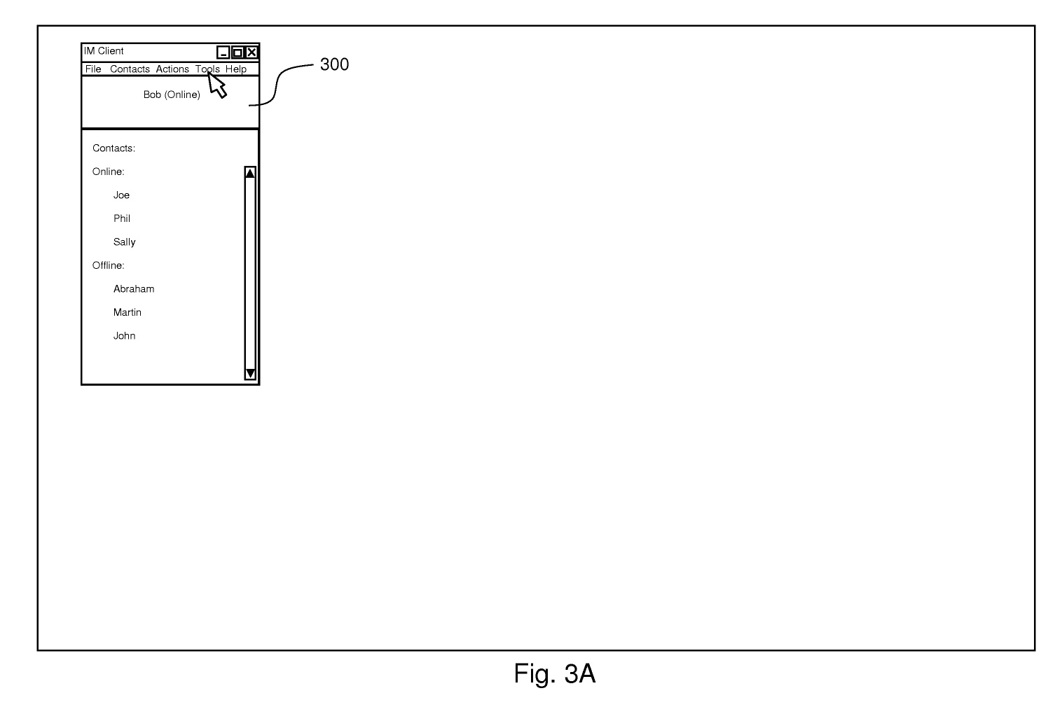

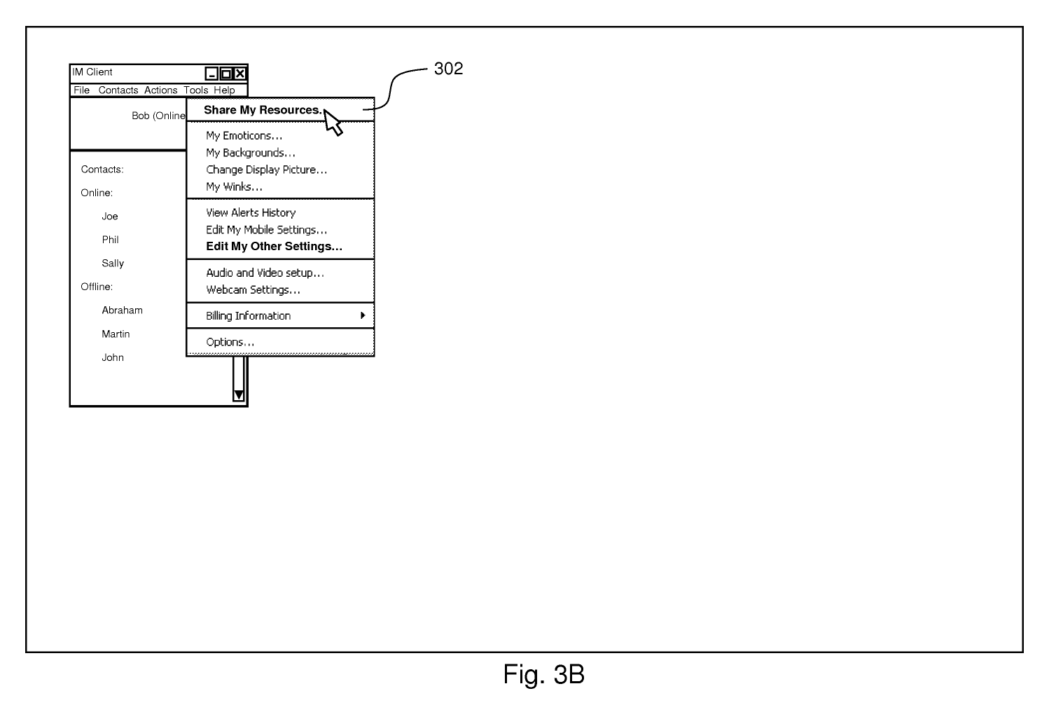

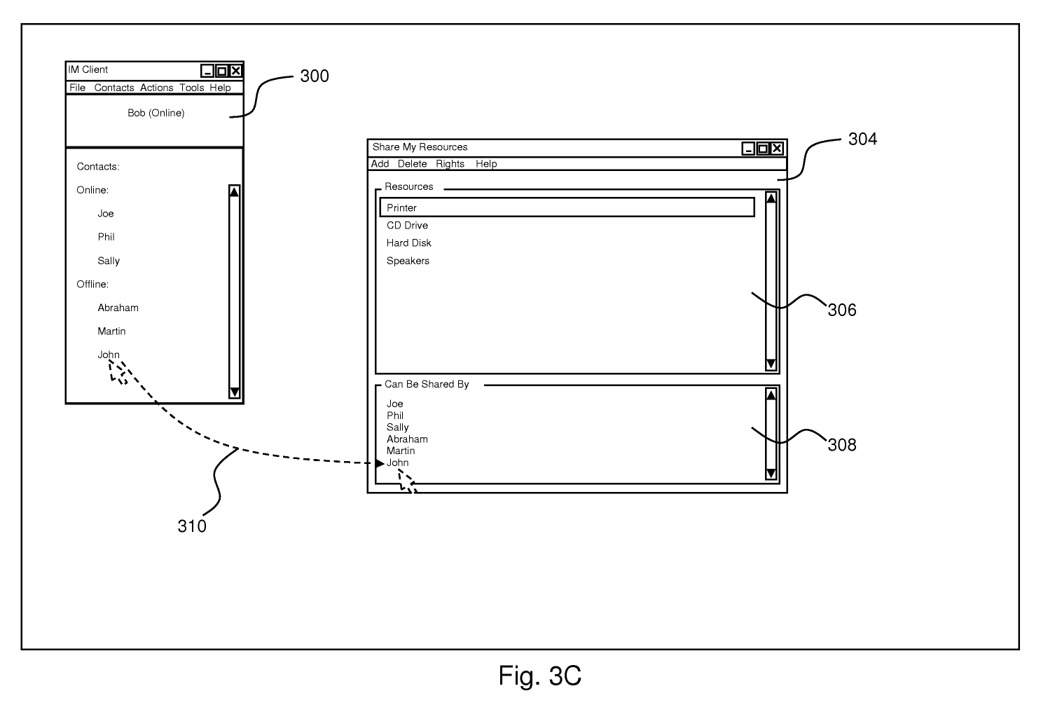

Reference is now made to FIGS. 3A-3C, which is a simplified illustration of exemplary interface elements of the system of FIG. 1, operative in accordance with an embodiment of the present invention. In FIG. 3A an instant messaging interface 300 is shown on a display monitor of a computer user named “Bob” in which various other users of the instant messaging system that are known to Bob are listed in a contact list. In FIG. 3B Bob selects a menu option 302 in order to manage resources that are accessible to Bob's computer and that are to be made available to one or more of Bob's contacts. In FIG. 3C a resource management window 304 is shown having a list of resources 306, as well as a list of users 308 indicating which of Bob's contacts may Bob's listed resources. In the embodiment shown users in Bob's contact list in instant messaging interface 300 may be clicked and dragged to list of users 308 as is shown by a dashed arrow 310.

It will be appreciated that by expanding the applications of data communications client platforms to include the sharing of any resource which is a component of or is connected to a computer, the sharing of such resources over a network is made simpler and easier than the methods offered by the current technologies. Additionally, by taking advantage of the security measures built into data communications client platforms, owners of computers can freely share their resources within their own selected community of remote users without the fear of unauthorized intruders.

While the methods and apparatus herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A resource sharing system comprising:
a resource manager configured to maintain a list of resources that are accessible to a first computer; and
a rights manager configured to maintain a list of users that may access any of said resources of said first computer,
wherein said resource manager and rights manager are configured to process a request to use any of said resources,
wherein said request is sent from a second data communications client at a second computer and received at a first data communications client at said first computer,
wherein said first data communications client is configured to recognize communications from said second data communications client as associated with a user identity that is known to said client, and
wherein said rights manager is configured to allow the transfer of data between said resource and said second data communications client via said first data communications client upon determining that said user is authorized to use said requested resource.

2. A system according to claim 1 wherein said rights manager is configured to maintain a list of any restrictions applicable to any of said users regarding any of said resources.

3. A system according to claim 1 wherein said data communications clients are configured to communicate with each other unhindered by firewalls or other security measures implemented to protect any of said computers.

4. A system according to claim 1 wherein said data communications clients are instant messaging (IM) programs.

5. A system according to claim 1 wherein said computers are each on a different network.

6. A resource sharing method comprising:
maintaining a list of resources that are accessible to a first computer;
maintaining a list of users that may access any of said resources of said first computer;
receiving a request to use any of said resources, wherein said request is sent from a second data communications client at a second computer and received at a first data communications client at said first computer;
determining whether said request is associated with a user identity that is known to said client and whether said user is authorized to use said requested resource; and
allowing the transfer of data between said resource and said second data communications client via said first data communications client upon determining that said user is authorized to use said requested resource.

7. A method according to claim 6 wherein said maintaining a list of users comprises maintaining a list of any restrictions applicable to any of said users regarding any of said resources.

8. A method according to claim 6 and further comprising performing any of said steps where said data communications clients are configured to communicate with each other unhindered by firewalls or other security measures implemented to protect any of said computers.

9. A method according to claim 6 and further comprising performing any of said steps where said data communications clients are instant messaging (IM) programs.

10. A method according to claim 6 and further comprising performing any of said steps where said computers are each on a different network.

11. A computer program embodied on a computer-readable medium, the computer program comprising:
a first code segment operative to maintain a list of resources that are accessible to a first computer;
a second code segment operative to maintain a list of users that may access any of said resources of said first computer;
a third code segment operative to receive a request to use any of said resources, wherein said request is sent from a second data communications client at a second computer and received at a first data communications client at said first computer;
a fourth code segment operative to determine whether said request is associated with a user identity that is known to said client and whether said user is authorized to use said requested resource; and
a fifth code segment operative to allow the transfer of data between said resource and said second data communications client via said first data communications client upon said fourth code segment determining that said user is authorized to use said requested resource.
